(19) United States
(12) Patent Application Publication
(10) Pub. No.: US 2026/0149927 A1
(43) Pub. Date: May 28, 2026

(54) SPEAKER SYSTEM WITH SLANTINGLY DISPOSED AND CIRCULARLY CURVED REFLECTION CHAMBER

(71) Applicant: ELECINIC CORP., New Taipei City (TW)

(72) Inventors: Chao-Lang WANG, New Taipei City (TW); Chien-Cheng WANG, New Taipei City (TW)

(73) Assignee: ELECINIC CORP., New Taipei City (TW)

(21) Appl. No.: 19/052,339

(22) Filed: Feb. 13, 2025

(30) Foreign Application Priority Data
Nov. 27, 2024 (TW) 113145885

(51) Int. Cl. H04R 7/02; H04R 1/02

(52) U.S. Cl. CPC H04R 7/02; H04R 1/02

(57) ABSTRACT

A speaker system with a slantingly disposed and circularly curved reflection chamber includes an enclosure, a speaker driver mountable at the front side of the enclosure, and a housing mountable at the rear side of the enclosure. The front side of the speaker driver forms a reference plane on a coordinate plane defined by a transverse axis and a longitudinal axis. The reflection chamber is formed at the front side of the housing, has a three-dimensional circularly curved configuration, has a portion located in the paths along which the speaker driver's acoustic waves propagate in the enclosure, so as to reflect such acoustic waves, and can be tilted with respect to the transverse axis and/or the longitudinal axis to form a transverse-direction angle and/or a longitudinal-direction angle between the reflection chamber and the reference plane. Accordingly, the asymmetric internal structure suppresses standing waves formation, improving the speaker system's acoustic performances.

### BACKGROUND OF THE INVENTION

### 1. Technical Field

The present disclosure relates to a speaker system, and more particularly to a speaker system with a reflection chamber having a three-dimensional circularly curved configuration and disposed slantingly with respect to a reference plane to form at least one of a transverse-direction angle and a longitudinal-direction angle.

### 2. Description of Related Art

Technically speaking, when it comes to the design of a speaker system, the optimization of acoustic performances has always been a major direction of research and development in the industry. In particular, efforts have been made to find ways to achieve superior sound quality using the limited space in a speaker system. Factors such as the structural design and spatial arrangement in a speaker system and the choices of materials have their respective effects on audio fidelity, the clarity of sound, the low-frequency response of the speaker system, and hence the overall sound quality of the system. Therefore, as users'demand for sound quality increases, speaker system designers have to overcome multiple technical challenges in order to enable high-fidelity sound effects.

More specifically, the geometric shapes and spatial layout of the internal structures of a speaker system, among others, affect the propagation paths of acoustic waves. In a symmetric space or a space of a regular shape, acoustic waves tend to be reflected along fixed paths, causing superposition or cancelation of acoustic waves, which results in an increase or attenuation of acoustic pressure at certain frequencies, namely the standing-wave phenomenon. This phenomenon not only distorts sound quality by making exceedingly loud sound in certain frequency bands, but also gives rise to a non-uniform sound field. Low-frequency acoustic waves, in particular, are highly susceptible to the shape of space and can form a particular acoustic pressure distribution that has negative effects on the clarity and richness of bass.

Speaker systems with symmetric internal structures are relatively easy to manufacture and are therefore in extensive use. However, an overly symmetric design of the structures in a speaker system will increase the number of times of acoustic wave reflection along the same paths and hence the probability of formation of standing waves, thus affecting the layers of sound and the faithfulness of sound reproduction. Moreover, standing waves will interfere with the diaphragm movement of a speaker driver and compromise the fidelity of sound reproduction, meaning the details of the original sound source will not be faithfully reproduced.

As stated above, the design of a speaker system involves technical challenges in various aspects. One of the issues to be addressed in the present disclosure is to reduce the probability of formation of standing waves while decreasing the difficulty in design and manufacture, so as to improve the acoustic performances of a speaker system and increase the clarity and fidelity of the sound replayed.

### BRIEF SUMMARY OF THE INVENTION

To stand out in a competitive market, based on the research spirit striving for excellence, and as a result of longtime research and experiments, a speaker system with a slantingly disposed and circularly curved reflection chamber is provided in the present disclosure, so as to effectively control standing waves and lessen their effects on the sound quality.

Certain aspects of the present disclosure are directed to a speaker system with a slantingly disposed and circularly curved reflection chamber. The speaker system includes an enclosure, a speaker driver and a housing. The speaker driver is configured to be mounted at the front side of the enclosure. The front side of the speaker driver forms a reference plane located on a coordinate plane defined by a transverse axis and a longitudinal axis. The housing is configured to be mounted at the rear side of the enclosure and has the circularly curved reflection chamber. The circularly curved reflection chamber is formed at a front side of the housing; has a three-dimensional circularly curved configuration, and at least a portion located in paths along which acoustic waves of the speaker driver propagate in the enclosure; and is configured to reflect the acoustic waves of the speaker driver, be tilted with respect to at least one of the transverse axis and the longitudinal axis, and form at least one of a transverse-direction angle and a longitudinal-direction angle between the circularly curved reflection chamber and the reference plane. Accordingly, the asymmetric internal structure can suppress the formation of standing waves, thereby improving the speaker system's acoustic performances

In certain embodiments, the transverse-direction angle is greater than 0 degree and less than 90 degrees, and the longitudinal-direction angle is zero.

In certain embodiments, the longitudinal-direction angle is greater than 0 degree and less than 90 degrees, and the transverse-direction angle is zero.

In certain embodiments, the transverse-direction angle is greater than 0 degree and less than 90 degrees, and the longitudinal-direction angle is greater than 0 degree and less than 90 degrees.

In certain embodiments, the circularly curved reflection chamber has a circularly curved cross section, and a central angle of the cross section is less than 180 degrees.

In certain embodiments, the outer contour of the housing is the same as the shape of the circularly curved reflection chamber.

In certain embodiments, the speaker system further includes at least one inverter tube corresponding in position to a higher side of the slanting housing, each of two ends of the inverter tube has an opening, and the openings are in communication with each other.

In certain embodiments, the at least one inverter tube is located at the front side of the enclosure and extends into the enclosure.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE SEVERAL VIEWS OF THE DRAWINGS

The present disclosure will become more fully understood from the following detailed description and accompanying drawings.

FIG. 1 is a perspective front view of a speaker system according to certain embodiments of the present disclosure.

FIG. 2 is a perspective rear view of a speaker system according to certain embodiments of the present disclosure.

FIG. 3 is a right-side view of a speaker system according to certain embodiments of the present disclosure.

FIG. 4 is a top view of a speaker system according to certain embodiments of the present disclosure.

FIG. 5 is a schematic diagram of the longitudinal-direction angle between a circularly curved reflection chamber and a reference plane according to certain embodiments of the present disclosure.

FIG. 6 is a schematic diagram of the transverse-direction angle between a circularly curved reflection chamber and a reference plane according to certain embodiments of the present disclosure.

FIG. 7 is a schematic diagram showing the locations of a housing and at least one inverter tube in a speaker system according to certain embodiments of the present disclosure.

### DETAILED DESCRIPTION OF THE INVENTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the term “and/or” includes any and all combinations of one or more of the associated listed items. Titles or subtitles can be used herein for the convenience of a reader, which shall have no influence on the scope of the present disclosure.

The accompanying drawings are schematic and may not have been drawn to scale. The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, materials, objects, or the like, which are for distinguishing one component/material/object from another one only, and are not intended to, nor should be construed to impose any substantive limitations on the components, materials, objects, or the like. Directional terms (e.g., “front”, “rear”, “left”, “right”, “upper/top” and/or “lower/bottom”) are explanatory only and are not intended to be restrictive of the scope of the present disclosure.

As used herein, the term “substantially” or “approximately” refers to, for example, a value, or an average of values, in an acceptable deviation range of a particular value recognized or decided by a person of ordinary skill in the art, taking into account any specific quantity of errors related to the measurement of the value that may be resulted from limitations of a measurement system or device. For example, “substantially” may indicate that the value is within, for example, ±5%, ±3%, ±1%, ±0.5% or ±0.1%, or one or more standard deviations, of the particular value.

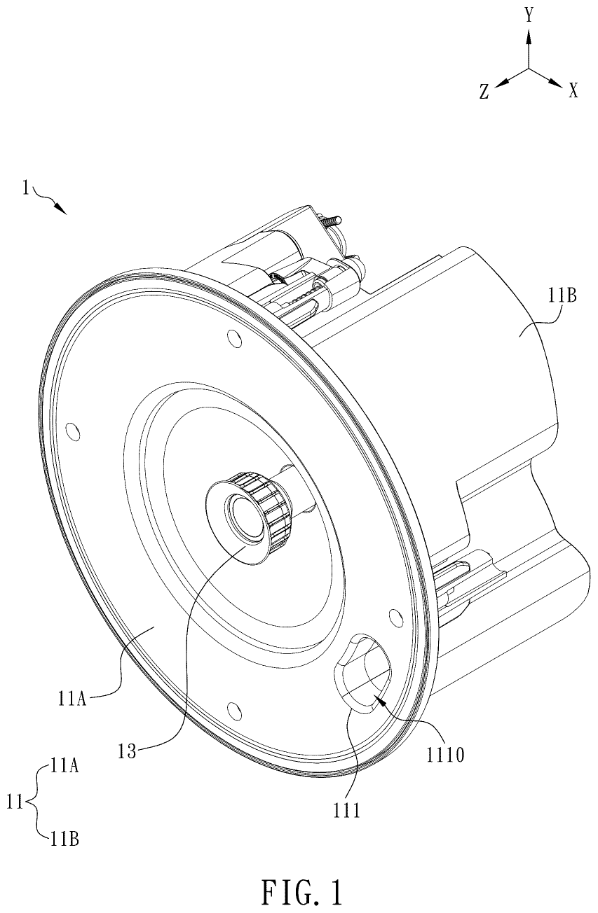

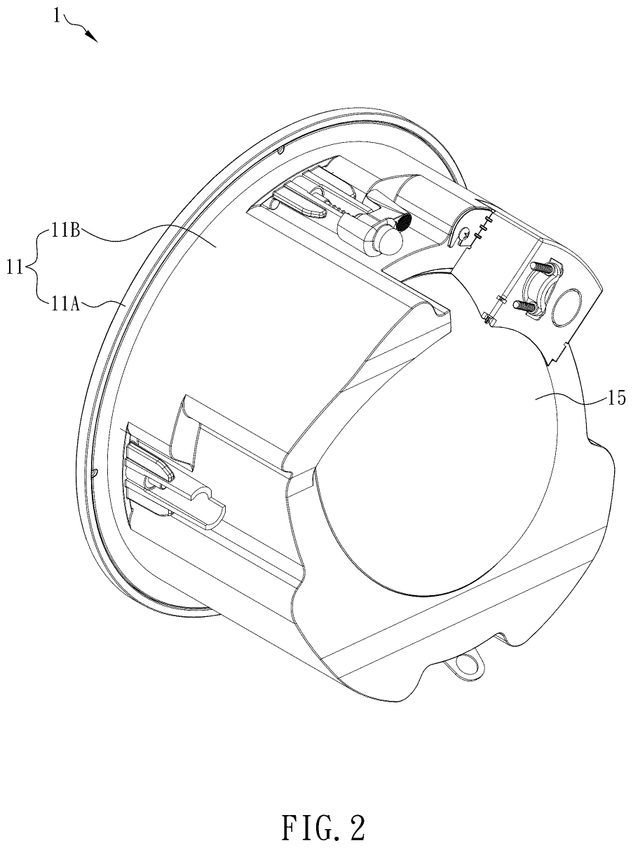

Certain aspects of the present disclosure are directed to a speaker system with a slantingly disposed and circularly curved reflection chamber. Referring to FIG. 1 to FIG. 4, in certain embodiments, the speaker system 1 includes an enclosure 11, a speaker driver 13, and a housing 15. To facilitate description of element features and relative positional relationship, the spatial configuration of the elements as used in the present disclosure is defined by three axes that are perpendicular to one another, namely a transverse axis (the X axis), a longitudinal axis (the Y axis), and a depth axis (the Z axis). As the speaker system 1 involves the way of placing the housing 15, the front side of the speaker driver 13 forms a reference plane R that serves as a reference in adjusting the position of the housing 15 with respect to the speaker driver 13. The reference plane R is not the sunken area on the front side of the speaker driver 13 but is an imaginary plane extending from the peripheral frame of the speaker driver 13.

With continued reference to FIG. 1 to FIG. 4, the reference plane R is on a coordinate plane defined by the transverse axis (the X axis) and the longitudinal axis (the Y axis). The transverse axis (the X axis) refers to a direction that extends between the right side and the left side, wherein the upper left corner of FIG. 1 is defined as a position on the left side of an element, the lower right corner of FIG. 1 is defined as a position on the right side of an element; the longitudinal axis (the Y axis) refers to a direction that extends between the top side and the bottom side, wherein the top edge of FIG. 1 is defined as a position on the upper side (the top side) of an element, and the bottom edge of FIG. 1 is defined as a position on the lower side (the bottom side) of an element. The depth axis (the Z axis) refers to a direction that extends between the front side and the rear side, wherein the lower left corner of FIG. 1 is defined as a position in front of an element, and the upper right corner of FIG. 1 is defined as a position behind an element.

With continued reference to FIG. 1 to FIG. 4, the front side of the enclosure 11 is configured to be mounted with the speaker driver 13, the rear side of the enclosure 11 is configured to be mounted with the housing 15, and the interior space of the enclosure 11 is configured to be mounted with the electronic components, circuit boards, circuits, and so on that are required for normal operation of the speaker system 1. In certain embodiments, the enclosure 11 includes a front cover member 11A and a hollow enclosure member 11B. The speaker driver 13 is configured to be mounted on the front cover member 11A, and the housing 15 is configured to be mounted on the hollow enclosure member 11B. However, the present disclosure is not limited thereto. In certain embodiments, based on actual needs, the enclosure 11 can be a single element or includes a plurality of components. In certain embodiments, the enclosure 11 is integrally formed with the housing 15, with the housing 15 still retaining the structural features as described infra. The shape and exterior of the enclosure 11 can be adjusted according to product requirements, and therefore are not limited to the configuration presented in FIG. 1, so as to increase the flexibility of the speaker system 1 in product design and satisfy the preferences of consumers in different age groups.

With continued reference to FIG. 1 to FIG. 4, the front side of the speaker driver 13 can be exposed from the enclosure 11, and when the speaker driver 13 is driven, the driver diaphragm thereof vibrates to generate acoustic waves, which propagate into and out of the enclosure 11. The acoustic waves generated by the speaker driver 13 and propagating into the enclosure 11 can reach the housing 15. Based on product needs, the type of the speaker driver 13 can include but is not limited to a sub-woofer, a mid-range driver, a tweeter, a horn driver, or a full-range driver. As long as a speaker driver can generate acoustic waves and work with the housing 15 as described infra, such a speaker driver falls within the scope of the speaker driver 13 defined in the present disclosure.

With continued reference to FIG. 1 to FIG. 4, the front side of the housing 15 is concave and forms a circularly curved reflection chamber 150. The circularly curved reflection chamber 150 has a three-dimensional circularly curved configuration. In certain embodiments, the outer contour of the housing 15 also has a three-dimensional circularly curved configuration, and the central angle of the outer contour of the housing 15 is substantially the same as the central angle of the circularly curved reflection chamber 150. However, the present disclosure is not limited thereto. In certain embodiments, based on product needs, the outer contour of the housing 15 can be different from the shape of the circularly curved reflection chamber 150. In addition, the circularly curved reflection chamber 150 has a circularly curved cross section, and the central angle of the cross section is less than 180 degrees; in other words, the curve corresponding to the cross-sectional shape of the circularly curved reflection chamber 150 is shorter than a complete semicircle defined by the same center of circle and radius. However, the present disclosure is not limited thereto. Further, at least a portion of the circularly curved reflection chamber 150 is located in the paths along which the acoustic waves of the speaker driver 13 propagate in the enclosure 11. Accordingly, the acoustic waves generated by the speaker driver 13 and propagating into the enclosure 11 to be reflected back and forth in the circularly curved reflection chamber 150 such that the circularly curved reflection chamber 150 serves as an acoustic wave reflection area. It is also noted that when the enclosure 11 is integrally formed with the housing 15, the part that has the circularly curved reflection chamber 150 is defined as the housing 15, while the rest is defined as the enclosure 11.

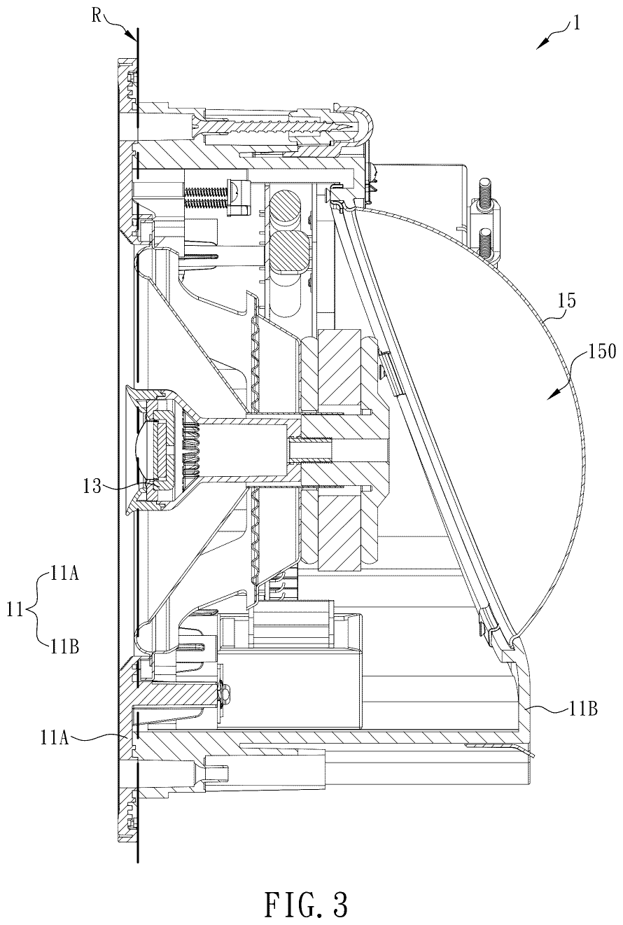

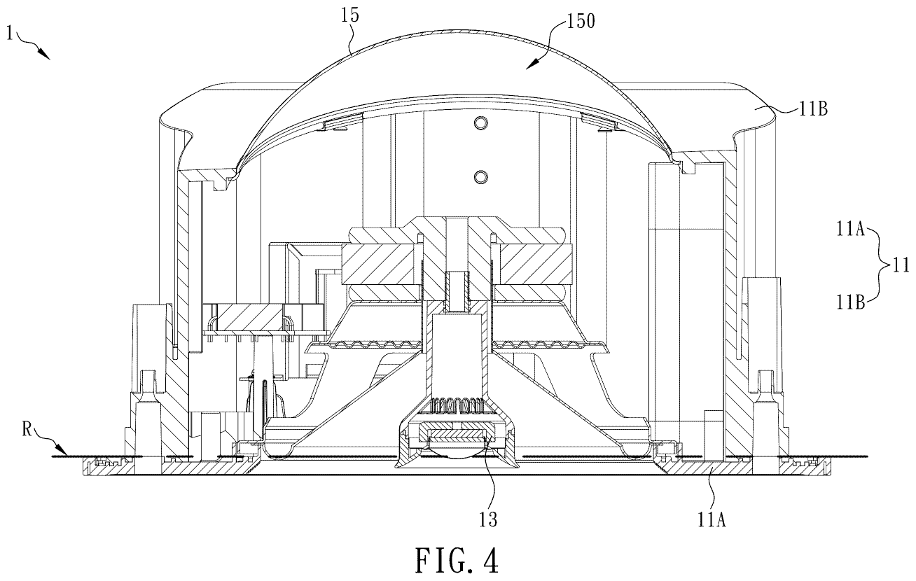

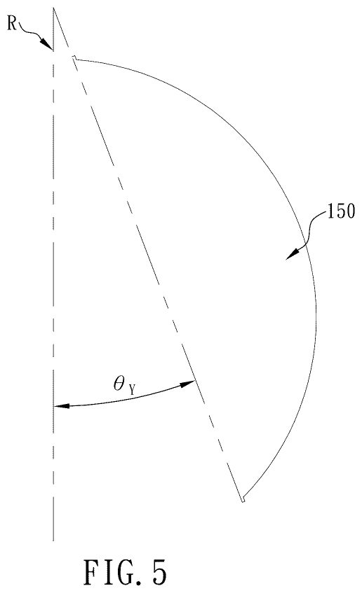

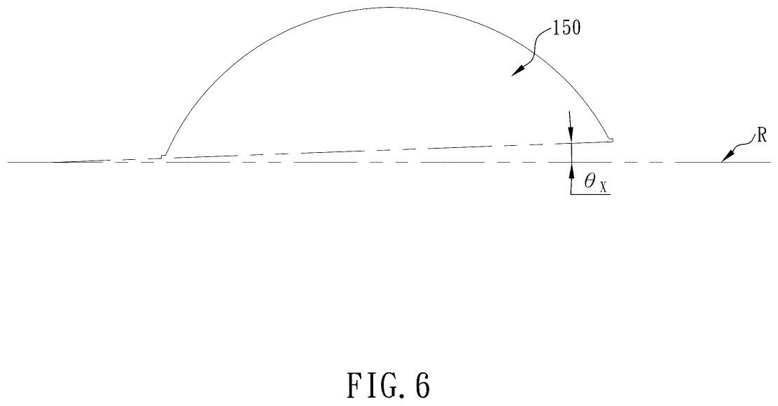

To make it easier to describe the relationship between the circularly curved reflection chamber 150 and the reference plane R, FIG. 5 and FIG. 6 show only the circularly curved reflection chamber 150 and the reference plane R. The reference plane R can be moved as needed in these drawings in order to be close to the circularly curved reflection chamber 150 to facilitate the marking of the included angle between the reference plane R and the circularly curved reflection chamber 150, and this change in position of the reference plane R is intended for angle marking purposes only and does not affect the definition of the reference plane R. As shown in FIG. 3 and FIG. 5, which are right-side views of the speaker system 1, the circularly curved reflection chamber 150 can be rotated about the transverse axis (i.e., the X axis) and thus tilted with respect to the longitudinal axis (i.e., the Y axis), forming a longitudinal-direction angle θ_{Y} between the circularly curved reflection chamber 150 and the reference plane R. Taking the transverse axis (i.e., the X axis) as a reference, the circularly curved reflection chamber 150 can be tilted upward or downward, and it should be pointed out that this angular relationship (i.e., the longitudinal-direction angle θ_{Y}) between the circularly curved reflection chamber 150 and the reference plane R is defined by the reference plane R and the reference plane defined by the opening of the circularly curved reflection chamber 150. In certain embodiments, as shown in FIG. 4 and FIG. 6, which are top views of the speaker system 1, the circularly curved reflection chamber 150 can be rotated about the longitudinal axis (i.e., the Y axis) and thus tilted with respect to the transverse axis (i.e., the X axis), forming a transverse-direction angle θ_{X} between the circularly curved reflection chamber 150 and the reference plane R. Taking the longitudinal axis (i.e., the Y axis) as a reference, the circularly curved reflection chamber 150 can be tilted leftward or rightward, and it should be pointed out that this angular relationship (i.e., the transverse-direction angle θ_{X}) between the circularly curved reflection chamber 150 and the reference plane R is defined by the reference plane R and the reference plane defined by the opening of the circularly curved reflection chamber 150.

Referring again to FIG. 5 and FIG. 6, based on product needs, in certain embodiments, the circularly curved reflection chamber 150 is tilted only with respect to the longitudinal axis (i.e., the Y axis), the longitudinal-direction angle θ_{Y} formed by the upward or downward tilt is greater than 0 degree and less than 90 degrees, and the transverse-direction angle θ_{X} is zero (i.e., no transverse-direction angle θ_{X} is formed). In certain embodiments, the circularly curved reflection chamber 150 is tilted only with respect to the transverse axis (i.e., the X axis), the transverse-direction angle θ_{X} formed by the leftward or rightward tilt is greater than 0 degree and less than 90 degrees, and the longitudinal-direction angle θ_{Y} is zero (i.e., no longitudinal-direction angle θ_{Y} is formed). In certain embodiments, the circularly curved reflection chamber 150 is tilted with respect to the transverse axis (i.e., the X axis) as well as to the longitudinal axis (i.e., the Y axis), so that each of the transverse-direction angle θ_{X} and the longitudinal-direction angle θ_{Y} is greater than 0 degree and less than 90 degrees. It is therefore known from the above that the circularly curved reflection chamber 150 and the reference plane R can form only the transverse-direction angle θ_{X}, only the longitudinal-direction angle θ_{Y}, or both the transverse-direction angle θ_{X} and the longitudinal-direction angle θ_{Y}.

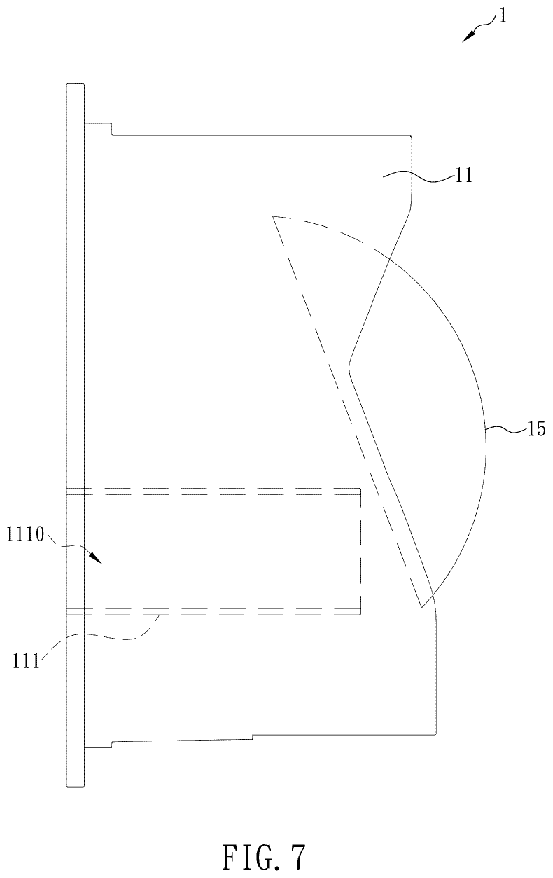

In addition, the internal volume of a speaker system has a significant impact on the sound quality of the system. Generally speaking, the greater the internal volume of a speaker system, the better the low-frequency response. Moreover, the larger the space in a speaker system, the more diverse the acoustic wave propagation and reflection paths, and hence the more profound the dynamics of, and the sense of ambience created by, the output sound. As the circularly curved reflection chamber 150 according to the present disclosure forms the transverse-direction angle θ_{X} and/or the longitudinal-direction angle θ_{Y} with the reference plane R, the housing 15 (and/or the circularly curved reflection chamber 150) is in a slanting position with respect to the reference plane R, i.e., with one side higher than the opposite side with respect to the reference plane R. Therefore, referring to FIG. 1 and FIG. 7, the speaker system 1 can be further provided with at least one inverter tube 111. In certain embodiments, the inverter tube 111 is located at the front side of the enclosure 11 and extends into the enclosure 11. Each of the two ends of the inverter tube 111 has an opening, and the openings are in communication with each other such that an internal passage space 1110 is formed. However, the present disclosure is not limited thereto. In certain embodiments, the inverter tube 111 can be located at the rear side of the enclosure 11 and extends into the enclosure 11. Further, the inverter tube 111 can correspond in position to, or be at least adjacent to, the side of the housing 15 that is relatively far away from the reference plane R, i.e., the inverter tube 111 corresponds in position to the higher side of the slanting housing 15 (and/or the circularly curved reflection chamber 150) with respect to the reference plane R. This design not only increases the paths along which the reflected acoustic waves propagate out of the outer opening of the inverter tube 111, but also reduces the intensity (i.e., amplitude) of undesirable reflected acoustic waves, such that the low-frequency performance of the speaker system 1 is enhanced in the richness of sound.

In summary of the above, referring to FIGS. 1-7, The speaker system 1 has the following effects.
(1) The circularly curved reflection chamber 150 in the housing 15 has a circularly curved configuration, so the reflective surface of the circularly curved reflection chamber 150 is a circularly curved surface. Such shapes increase the probability that the angles of incidence of the reflected acoustic waves are not zero, and this in turn reduces the reflected acoustic waves returning to, and interfering with, the driver diaphragm, contributing to enhanced audio fidelity of the speaker driver 13.
(2) As the aforesaid circularly curved surface is a symmetric structure in terms of geometry and therefore tends to result in regular reflection of acoustic waves and hence the formation of standing waves, the circularly curved reflection chamber 150 in the present disclosure is tilted with respect to the reference plane R to break the symmetry and thereby reduce the formation of standing waves in the housing 15. As a result, excessive resonance can be reduced, and so can acoustic waves that vibrate unnaturally. The foregoing structure also helps preserve the completeness of sound, so that the sound replayed is faithful to the original sound source and is significantly enhanced in clarity.
(3) In addition to lowering the chance of standing wave formation, the slanting position of the housing 15 (and/or the circularly curved reflection chamber 150) helps increase the number of times of propagation and reflection of acoustic waves in the speaker system 1. Moreover, with the inverter tube 111 corresponding in position to the higher side of the slanting housing 15 (and/or the circularly curved reflection chamber 150) with respect to the reference plane R, the paths along which acoustic waves propagate out of the outer opening of the inverter tube 111 are lengthened. The aforesaid designs jointly produce an effect equivalent to increasing the internal volume of the speaker system 1.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A speaker system, comprising:
an enclosure;
a speaker driver configured to be mounted at a front side of the enclosure, wherein a front side of the speaker driver forms a reference plane located on a coordinate plane defined by a transverse axis and a longitudinal axis; and
a housing configured to be mounted at a rear side of the enclosure and having:
a slantingly disposed and circularly curved reflection chamber formed at a front side of the housing; having a three-dimensional circularly curved configuration, and at least a portion located in paths along which acoustic waves of the speaker driver propagate in the enclosure; and configured to reflect the acoustic waves of the speaker driver, be tilted with respect to at least one of the transverse axis and the longitudinal axis, and form at least one of a transverse-direction angle and a longitudinal-direction angle between the circularly curved reflection chamber and the reference plane.

2. The speaker system according to claim 1, wherein the transverse-direction angle is greater than 0 degree and less than 90 degrees, and the longitudinal-direction angle is zero.

3. The speaker system according to claim 1, wherein the longitudinal-direction angle is greater than 0 degree and less than 90 degrees, and the transverse-direction angle is zero.

4. The speaker system according to claim 1, wherein the transverse-direction angle is greater than 0 degree and less than 90 degrees, and the longitudinal-direction angle is greater than 0 degree and less than 90 degrees.

5. The speaker system according to claim 1, wherein the circularly curved reflection chamber has a circularly curved cross section, and a central angle of the cross section is less than 180 degrees.

6. The speaker system according to claim 1, wherein an outer contour of the housing is the same as a shape of the circularly curved reflection chamber.

7. The speaker system according to claim 1, further comprising at least one inverter tube corresponding in position to a higher side of the slanting housing, wherein each of two ends of the inverter tube has an opening, and the openings are in communication with each other.

8. The speaker system according to claim 7, wherein the at least one inverter tube is located at the front side of the enclosure and extends into the enclosure.
